(19) United States
(12) Patent Application Publication
(10) Pub. No.: US 2023/0415529 A1
(43) Pub. Date: Dec. 28, 2023

(54) DEVICE FOR CONNECTING MODULAR VEHICLES

(71) Applicant: GETPLUS S.R.L., Padova (IT)

(72) Inventor: Tommaso GECCHELIN, Padova (IT)

(21) Appl. No.: 18/252,729

(22) PCT Filed: Aug. 24, 2021
(86) PCT No.: PCT/IB2021/057738

§ 371 Date: May 12, 2023

(30) Foreign Application Priority Data
Nov. 16, 2020 (IT) 102020000027348

(51) Int. Cl. B60D 1/48; B60D 1/36; B60D 1/62; B60D 1/24

(52) U.S. Cl. CPC B60D 1/481; B60D 1/36; B60D 1/62; B60D 1/246

(57) ABSTRACT

A modular vehicle connection device for rigidly connecting in motion at least one leading vehicle and one trailing vehicle, wherein the device includes, for each vehicle, at least one spar, extending for the entire length of the vehicles, the spar including a front cavity and a rear cavity, both cavities open outwards, the rear cavity housing an actuator and an extension of the spar, the actuator connected to one end of the extension, adapted to move the extension to position an extension of the leading vehicle partly in a front cavity of the tail vehicle and partly in a rear cavity of the lead vehicle to rigidly connect the two vehicles. The front and rear cavities are equipped with locking device in position of the extension.

### FIELD OF THE INVENTION

The present invention relates to a device for connecting modular vehicles able to rigidly connect at least one leading vehicle and one trailing vehicle, of the type specified in the preamble of the first claim.

Specifically, said connection device is adapted to form a rigid train of modular vehicles, without relative rotations between said vehicles.

### BACKGROUND OF THE INVENTION

Devices and technologies are currently known for connecting a plurality of vehicles, whether they are identical vehicles or systems with tractor and trailer.

Most of the systems of the prior art require an operator near the coupling system to operate or make the connection, for example in systems such as tow hook or fifth wheel.

In addition, the known art basically provides articulated coupling systems, which allow relative rotation between the coupled vehicles.

Examples of devices for rigid connection, without relative rotations between the components of the connection, are described in documents CN109987016 and WO2018226615.

Document CN109987016 describes a delivery device comprising at least two vehicles adapted to be connected together along one side. Said device comprises a system with guide rollers and rails placed laterally to each vehicle, said systems are able to mechanically couple. The vehicles thus coupled form a single internal compartment accessible by both vehicles.

Furthermore, document WO2018226615 describes a device and a method for the formation of autonomous vehicles for the delivery of goods. Specifically, the document describes an automatic connection system equipped with magnetic vehicle restraint means.

The known technique described comprises some important drawbacks.

In particular, the devices of the prior art do not allow to couple several modular vehicles in motion and/or in the presence of a misalignment between the vehicles. Furthermore, the devices of the known art provide for the use of optical, electronic or digital alignment systems, which are complex and expensive.

### SUMMARY OF THE INVENTION

In this situation, the technical task underlying the present invention is to devise a device for connecting modular vehicles capable of substantially obviating at least part of the aforementioned drawbacks.

Within the scope of said technical task, an important object of the invention is to obtain a device adapted to rigidly connect, or rather without relative rotation between vehicles, a plurality of modular vehicles.

Another important object of the invention is to provide a device that can connect modular vehicles when in motion.

Still, an important object of the invention is to provide a device that can be used and activated by a driver of a modular vehicle, without getting off said vehicle, without the aid of electronic positioning and/or alignment systems.

The technical task and the specified aims are achieved by a modular vehicle connection device as claimed.

Preferred technical solutions are highlighted in the dependent claims.

### BRIEF DESCRIPTION OF THE DRAWINGS

The characteristics and advantages of the invention are clarified below by the detailed description of preferred embodiments of the invention, with reference to the accompanying figures, in which:

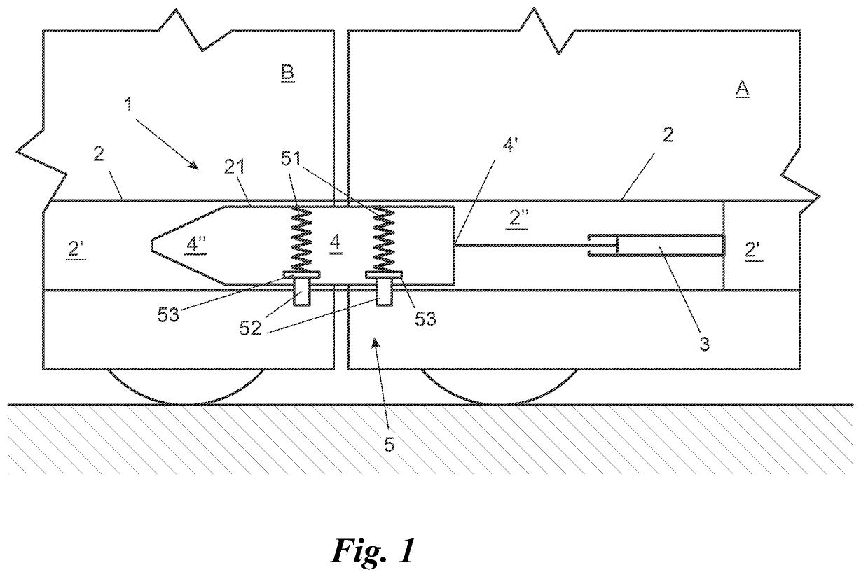

the FIG. 1 shows a sectional view of the modular vehicle and the connecting device object of the invention;

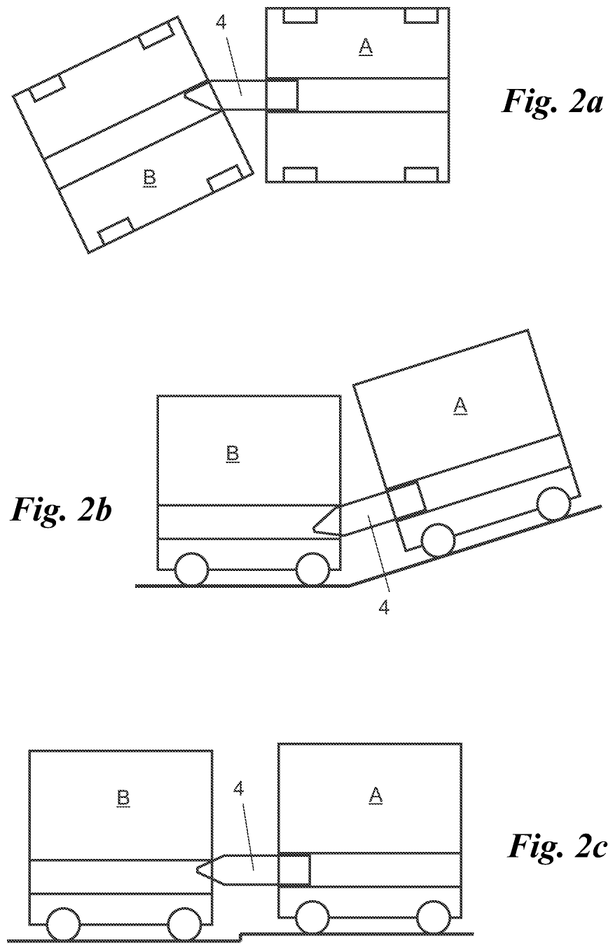

the FIGS. 2a, 2b and 2c illustrate the connection between two vehicles equipped with the connecting device according to the present invention, in different relative positions of the two vehicles.

### DETAILED DESCRIPTION OF THE PREFERRED EMBODIMENTS

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the Figures, the device according to the invention is globally indicated with the number 1.

As will be clear in the following of the document, the device 1 is able to be installed on a plurality of vehicles being in fact a modular device 1 present identical on each vehicle able to compose the system.

The modular vehicle connection device 1 adapted to rigidly connect at least one leading vehicle A and one trailing vehicle B in motion. It is also clear that the rigid connection thus made can involve a plurality of vehicles.

Said vehicles A, B are removably connectable to each other, and when connected they form a rigid train without relative rotations between said vehicles A, B. The device 1 is therefore adapted to connect the vehicles in such a way that the joined vehicles form a body dynamically unique. Said vehicles A, B therefore form a rigid train without relative rotations in a horizontal plane, in a lateral plane and in a vertical plane.

According to the present invention, preferably each vehicle A, B comprises at least one supporting spar 2, extending for the entire length of said vehicles A, B.

By spar 2, as visible in FIG. 1 is meant a structural element arranged substantially parallel to the direction of travel, integrally connected to the chassis of said vehicles. Preferably, said spar 2 is placed centrally with respect to the axes of the wheels of the vehicle A, B.

Also, preferably, said longitudinal member 2 comprising a front cavity 2′ and a rear cavity 2″. Said cavities 2′, 2″ are both open towards the outside, therefore they define a front opening and a rear opening of the spar.

Preferably, according to the present invention, said rear cavity 2″ houses an actuator 3 and an extension 4 of said spar 2.

In the present document, the extension 4 of said spar 2 means a rigid mechanical element, sized to resist bending stresses and torsion and other nature acting between two connected vehicles, adapted to act as a structural extension of the spar 2 and in general of the chassis of the vehicle.

When not in use, or rather when no trailing vehicle B is coupled to a leading vehicle A, the extension 4 is retained inside the rear cavity 2″ of the vehicle A by said actuator 3, said extension 4 does not therefore protrude from the external shape of said vehicle A.

Again, preferably, according to the present invention, said actuator 3 is connected to an end 4′ of said extension 4. The actuator 3 described here can consist of any system of the prior art suitable for to move said extension 4.

Said actuator 3 is therefore adapted to move said extension 4 so as to position an extension 4 of the leading vehicle A partly in a front cavity 2′ of the tail vehicle B and partly in a rear cavity 2″ of the leading vehicle A in order to rigidly connect said two vehicles A, B.

Finally, for each vehicle A, B, said front and rear cavities 2′, 2″ are equipped with locking means 5 in position of said extension 4.

The extension 4 then is positioned astride the two vehicles A and B, rigidly connecting the two side members of the spars 2,2 of the vehicles, acting as a frame in the rigid connection between the vehicles which now move like a rigid train. Furthermore, the extension 4 is provided with a further end 4″. As shown in FIG. 1, the extension 4 is connected at one end 4′ to the actuator 3, the other free end 4″ is therefore facing the vehicle to be connected.

Preferably, according to the present invention, at least one end 4″ of said extension 4 defines a pyramidal shape. In more preferably, at least one end 4″ of said extension 4 defines a pyramidal shape whose lateral faces have different inclinations. The extension 4 therefore in this embodiment is provided with a tapered end 4″ and with a non-tapered body.

The pyramidal shape of the end 4″ of the extension 4 is therefore able to facilitate the connection, and more specifically it is able to define the angles of connection between two vehicles A and B. In fact, according to the inclinations of the lateral faces of the end 4″ it is possible to connect two vehicles A, B in different conditions, shown in FIGS. 2a, 2b and 2c.

The FIG. 2a shows the possible connection between two vehicles A and B misaligned in a horizontal plane, contemplating for example the position of two vehicles in curves; as visible, the end 2″ facilitates the connection and therefore the insertion of the end 4″ of the extension 4 of the leading vehicle A into the front cavity 2″ of the spar 2 of the trailing vehicle B.

Again, as shown in FIG. 2b, it is possible to connect with the device 1 in a situation of misalignment between vehicles A, B when for example the leading vehicle A is uphill. The conformation of the end 4″, and therefore the upper and lower lateral faces of the pyramid, allow and/or facilitate the connection in this case.

Finally, as shown in FIG. 2c, the device 1 according to the present invention allows to connect two vehicles A, B under different conditions of mutual load, with consequent impact on, for example, the suspension system which varies the height of the vehicle.

Again, preferably, the dimensions of said extension 4 of said spar 2 and the dimensions and shapes of said end 4″ are sized to ensure that once the non-tapered part of said extension 4 has been reached, the vehicles are already aligned between them.

In fact, in a first moment of the connection, two vehicles A, B can be off-centered from each other, as shown in FIGS. 2a, 2b and 2c, and said off-center can be partially recovered thanks to the conformation of the end 4″ of the extension 4A of the leading vehicle A. Continuing in the connection, being specifically the dimensions and shapes of the front cavity 2′ of the spar 2 of the trailing vehicle B similar to those of the non-tapered part 4′ of the extension 4 of the leading vehicle A, the connection following the end 4″ on the extension 4 forces the trailing vehicle B to align itself along the direction of the longitudinal member (spar) 2 of the leading vehicle A, said obligation imposed by the mechanical constraint represented by the shape of the extension 4.

In addition, preferably the locking means 5 in position of said extension 4 comprise at least one contrast spring 51 able to block the movement of said extension 4 constraining it by interference to an internal surface 21 of said spar 2 Said spring acts in a direction that is not parallel, and preferably substantially perpendicular, to the direction of prevailing extension of the extension 4.

Again, preferably, said locking means 5 in position of said extension 4 comprise pistons 52 adapted to actuate mechanical stops 53 adapted to rigidly connect at least said extension 4 to said spars 2, 2 of said vehicles A, B.

Preferably therefore, the extension 4 is held in position by mechanical stops 53 activated by mechanically, pneumatically, hydraulically, electrically operated pistons 52 or combinations of the above. For each vehicle, the piston 52 and the stop 53 have the function of releasing the extension 4; on the other hand, the lock is guaranteed by the properly dimensioned compression spring 51, thus preventing any possible involuntary release. Preferably, said locking means 5 in position of said extension 4 are adapted to connect said non-tapered portion of said extension 4. This system allows a coupling and release in movement of the two vehicles A, B. Finally, preferably, in the device 1 according to the present invention said actuator 3 is further adapted to move said extension 4 of said longitudinal member 2 in at least two directions under the load of at least one vehicle A, B.

In fact, during the connection the extension 4 can be pushed by the actuator 3 near of the front cavity 2′ of the trailing vehicle B, said extension 4 being rigidly coupled to the side member of the spar 2 of the trailing vehicle B by the means of locking means 5 in position of said extension. In this situation, it is then possible for the actuator 3 of the leading vehicle A to pull the extension 4 and the vehicle connected to it until the leading A and trailing vehicle B form a rigid train of modular vehicles. The operation of the device 1 previously described in structural terms is as follows. Two vehicles A and B, driven respectively by a driver or by a remote or autonomous driving system, are in motion and need to be connected to each other by means of the device 1 described here.

Having recovered part of the misalignment between the vehicles, indifferently one of the two vehicles A or B approaches the other vehicle with a front cavity 2′ of one vehicle, for example A, facing a rear cavity 2″ of the other vehicle, for example B. The driver or the driving system of the vehicle A controls the actuation of the actuator 3 connected to the extension 4, which is now made to protrude from the rear face of the vehicle A itself, and connects at least with the end 4″ the front cavity 2′ of the spar 2 of the trailing vehicle B. With the end 4″ of vehicle A and the front cavity 2′ of vehicle B in contact, again there is a movement of one of the two vehicles A, B or of the actuator 3 of the leading vehicle A to bring said extension 4 at least partially in the spar 2 of the leading vehicle A and at least partially in the side member of the spar 2 of the trailing vehicle B. In this position the extension 4 is locked there. Optionally, the actuator 3 of the leading vehicle A can tow the trailing vehicle B, connected by locking means 5 in position to said extension 4, forming a rigid train of modular vehicles.

The device 1 according to the invention achieves important advantages.

In fact, unlike vehicles and means of connection between vehicles of the known art, advantageously the connection with the device 1 according to the present invention does not require optical and/or electronic systems for the connection but can be carried out by one or two operators driving the vehicles.

Furthermore, advantageously, the type of structural connection, similar to an extension of the frame between the two means, allows to obtain a vehicle that dynamically behaves as a single body and in fact this specific conformation makes any additional restraint system useless, such as for example the hooks on the 4 edges of the faces in contact with the vehicles.

Again, for what has been said, the solution described here becomes cheaper to build and maintain considering the minimum number of moving parts and electronic components used.

Finally, advantageously with respect to the known art which uses electronic, magnetic or mixed systems, the purely mechanical nature of the device 1 makes the functional safety of the highest level, in fact the coupling, once it has taken place, requires a voluntary release command of the means 5, and cannot in any way occur due to external physical causes such as bumps, shocks, slopes or lack of energy, electromagnetic interference.

The invention is susceptible of variants falling within the scope of the inventive concept defined by the claims.

In this context, all the details can be replaced by equivalent elements and the materials, shapes and dimensions can be any.

1. A device for connecting modular vehicles capable of rigidly connecting at least one leading vehicle and one trailing vehicle in motion, comprising, for each vehicle,
at least one supporting spar, extending for the entire length of said vehicles, said spar comprising a front cavity and a rear cavity, both said cavities open towards the outside,
said rear cavity hosting an actuator and an extension of said side spar,
said actuator, connected to one end of said extension, capable of moving said extension to position an extension of the lead vehicle partly in a front cavity of the trailing vehicle and partly in a rear cavity of the lead vehicle to rigidly connect said two vehicles,
said front and rear cavities equipped with locking means in position of said extension.

2. The device according to claim 1, wherein at least one end of said extension defines a pyramidal shape.

3. The device according to claim 1, wherein at least one end of said extension defines a pyramidal shape whose lateral faces have different inclinations.

4. The device according to claim 1, wherein at least one end of said extension defines a part of non-tapered shape, wherein size of said extension of said spar and sizes and shapes of said end are dimensioned to ensure that once the non-tapered part of said extension has been reached, the vehicles are already aligned with each other.

5. The device according to claim 1, wherein said locking means in position of said extension comprise at least one compression spring capable of blocking the movement of said extension constraining said extension by interference to an internal surface of said spar.

6. The device according to claim 5, wherein said spring acts in a direction not parallel to a direction of prevailing extension of said extension.

7. The device according to claim 6, wherein said spring acts in a direction substantially perpendicular to the direction of prevailing extension of said extension.

8. The device according to claim 1, wherein said locking means in position of said extension comprise pistons adapted to actuate mechanical stops adapted to rigidly connect at least said extension to said spars of said vehicles.

9. The device according to claim 1, wherein said locking means are configured to allow a moving engagement and release of said vehicles.

10. The device according to claim 1, wherein said actuator is further adapted to move said extension of said spar in at least two directions under the load of at least one vehicle.

11. The device according to claim 1, wherein one end of said extension is capable of extending from the rear cavity of the lead vehicle into the front cavity of the trailing vehicle defines a pyramidal shape, and an opposed end of said extension is said one end of said extension connected to the actuator and defines a part of non-tapered shape.

12. The device according to claim 1, wherein size of said extension of said spar and sizes and shapes of said ends of said extension are dimensioned to ensure that once the part of non-tapered shape of said extension has been reached, the vehicles are already aligned with each other.

13. The device according to claim 11, wherein said locking means in position of said extension comprise at least one compression spring capable of blocking the movement of said extension constraining said extension by interference to an internal surface of said spar.

14. The device according to claim 13, wherein said spring acts in a direction not parallel to a direction of prevailing extension of said extension.

15. The device according to claim 13, wherein said spring acts in a direction substantially perpendicular to a direction of prevailing extension of said extension.
